(19) United States
(12) Patent Application Publication
(10) Pub. No.: US 2023/0110938 A1
(43) Pub. Date: Apr. 13, 2023

(54) VEHICULAR VISION SYSTEM WITH REMOTE DISPLAY FEATURE

(71) Applicant: Magna Electronics Inc., Auburn Hills, MI (US)

(72) Inventor: Alan M. Cordeiro, Farmington Hills, MI (US)

(21) Appl. No.: 17/934,247

(22) Filed: Sep. 22, 2022

Related U.S. Application Data
(60) Provisional application No. 63/261,583, filed on Sep. 24, 2021.

(51) Int. Cl. H04N 7/18; H04N 5/225; H04N 5/247; H04N 5/232; H04W 4/44

(52) U.S. Cl. CPC H04N 7/181; H04N 5/247; H04N 5/2256; H04N 5/23206; H04W 4/44; B60Q 1/249

(57) ABSTRACT

A vehicular vision system includes at least one camera disposed at a vehicle a wireless communication module and an electronic control unit (ECU) that includes electronic circuitry and associated software. The electronic circuitry of the ECU includes an image processor for processing image data captured by the camera. The vehicular vision system, responsive to receiving a remote viewing communication from a remote device exterior of and remote from the vehicle, (i) enables at least one light source of the vehicle to illuminate a region and (ii) captures one or more frames of image data representative of at least a portion of the illuminated region. The vehicular vision system wirelessly transmits the one or more frames of image data to the remote device for display of images at the remote device.

### CROSS REFERENCE TO RELATED APPLICATION

The present application claims the filing benefits of U.S. provisional application Ser. No. 63/261,583, filed Sep. 24, 2021, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular vision system includes at least one camera disposed at a vehicle equipped with the vehicular vision system. The at least one camera captures image data. The at least one camera may include at least one million photosensing elements arranged in rows and columns. The vehicular vision system is operable to wirelessly communicate with a remote server. The system includes an electronic control unit (ECU) with electronic circuitry and associated software. The electronic circuitry of the ECU includes an image processor for processing image data captured by the camera. The vehicular vision system, responsive to receiving a remote viewing communication from a remote device exterior of and remote from the vehicle, (i) enables at least one light source of the vehicle to illuminate a region and (ii) captures one or more frames of image data representative of at least a portion of the illuminated region. The vehicular vision system wirelessly transmits the one or more frames of image data to the remote device for display of images at the remote device that are representative of the illuminated region.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras and that provides a remote viewing function to a user; and

FIG. 2 is a block diagram of the vision system of FIG. 1.

### DESCRIPTION OF THE PREFERRED EMBODIMENTS

A vehicle vision system and/or driver or driving assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide display, such as a rearview display or a top down or bird’s eye or a three dimensional (3D) surround view display or the like.

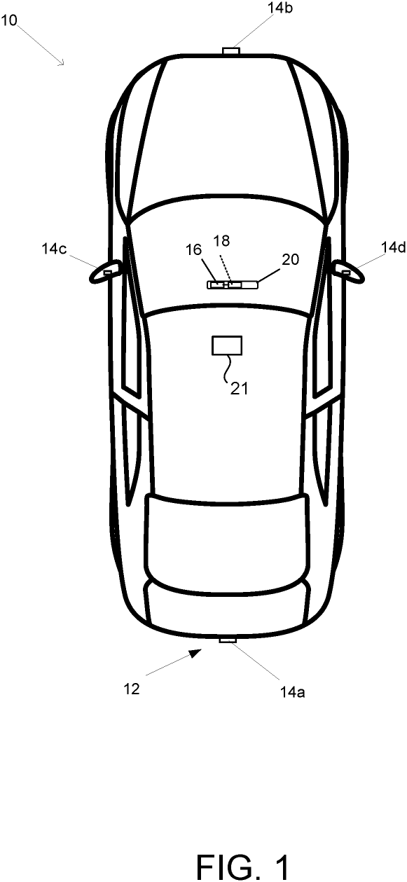

Referring now to the drawings and the illustrative embodiments depicted therein, a vehicle 10 includes an imaging system or vision system 12 that includes at least one exterior viewing imaging sensor or camera, such as a rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). Optionally, the system may include an interior viewing or cabin monitoring camera disposed in the vehicle and viewing at least a portion of the interior cabin of the vehicle. For example, one or more interior cameras 21 may be installed inside the vehicle cabin (e.g., at or near the headliner of the vehicle) to monitor the interior of the vehicle (e.g., for a driver monitoring system or an occupant monitoring system or cabin monitoring system or the like). The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

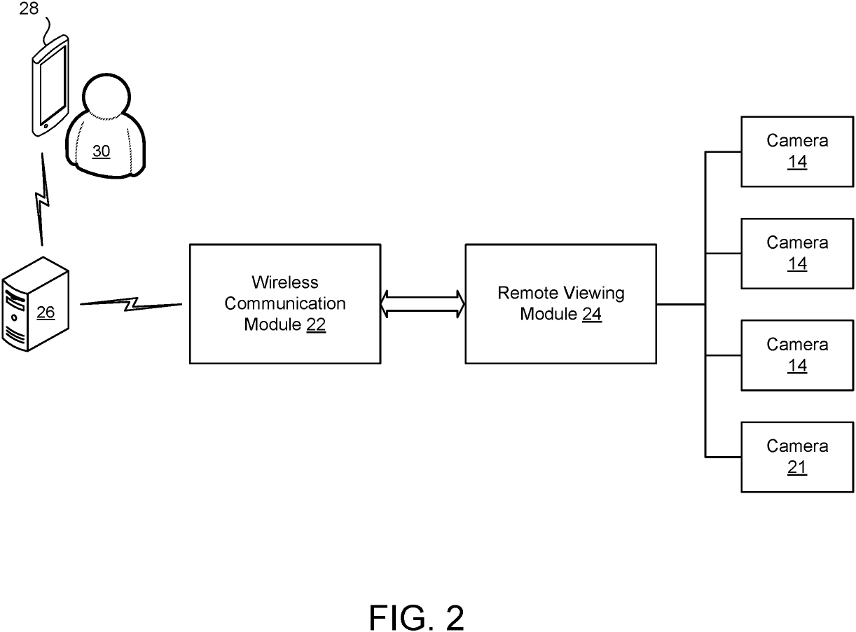

Many new vehicles include a module that provides an embedded cellular communication link (e.g., 3G, 4G, 5G, etc.) that establishes a wireless connection to designated servers in the cloud (e.g., via the Internet). Referring now to FIG. 2, implementations herein include a remote three-dimensional (3D) viewer 24 that utilizes an wireless communication module 22 to communicate via an integrated cellular (or other wireless communication, such as BLUETOOTH, WIFI, etc.) connection to allow a vehicle owner 30 to view the surroundings of their vehicle from a remote location (e.g., images captured by one or more cameras disposed at the vehicle). A vehicle owner may connect to the vehicle (e.g., via the Internet or the cloud) over the wireless communication link using an application executing on a computing device 28 such as a cell phone, laptop, desktop, tablet, etc. The user may request one or more images (captured by one or more exterior cameras 14 and/or interior cameras 21 of the vehicle) and/or video and/or audio (e.g., captured by one or more microphones disposed at or within the vehicle) of the external surroundings or the interior of the vehicle. The images may be from a single camera or the images may be a composite of image data captured by multiple cameras (e.g., a 3D bird’s-eye view of the outside of the vehicle including surroundings such as 20 to 30 meters around the vehicle or any other virtual viewpoint).

Optionally, a user executes an application (e.g., a smart phone application that may be downloaded and installed from an application repository) for the remote viewer. In some examples, the user may access the remote viewer via, for example, a web browser or other separate application. When the remote viewer app is executed, a connection may be established between the user device and a cloud data server. The cloud data server may connect (e.g., via the cellular communication network or other wireless network) with the vehicle. In other examples, the user device establishes a direct connection with the vehicle. In either case, a message may be sent to the user’s vehicle (e.g., from the server or the user device) to the vehicle’s communication module commanding functionality of the vehicle to enable or “wake up” (e.g., exit a low power mode). For example, the command may cause the vehicle bus to issue commands to a remote viewer module to be activated by sending one or more vehicle bus messages to the remote viewer module.

When the vehicle is asleep (i.e., in a low power mode), the local 3D viewing module in communication with one more cameras disposed at or within the vehicle may, upon receiving a command from the user via the wireless communication module, activate or enable or enter an operation mode (i.e., exit the low-power mode). That is, the module may awaken in response to vehicle bus traffic generated by the communications module. After the viewing module wakes up or enters the operation mode, the module may determine a cause or purpose for being enabled (e.g., by monitoring vehicle bus traffic). When the module determines that the cause is a request for remote view mode, the module may execute vision application software and switch into a special sub-mode of vision application software.

The 3D viewer module may receive inputs from one or more external cameras and create, for example, a 3D bird’s-eye view of the vehicle including its external surroundings. This generated view may be sent via the wireless connection module (e.g., via the Internet), which transmits the view (i.e., one or more frames of image data) to the cloud for ongoing transmission to the user device. Optionally, the user, via the user device, may select a view or virtual viewing location, and the 3D viewer module may change the perspective provided by the images sent to the user device. For example, the user may select which camera to receive image data from and/or pan, tilt, and/or zoom a specific camera. The user may select different composite views (e.g., move a virtual point of view) that include image data from any combination of available cameras. Optionally, the 3D viewer module at the vehicle processes the image data captured by the cameras. Alternatively or additionally, the cloud server and/or the user device performs some or all of the processing of the image data. For example, the vehicle may transmit the raw image data (compressed or uncompressed) while the server or user device processes the raw image data to generate the 3D bird’s-eye view.

Optionally, the 3D viewer module transmits the frames of image data (e.g., video data) in a universally accepted video format to the cloud via the wireless connection module. For example, the video stream may be compressed using any industry standard video compression, such as H0.264/H0.265/MPEG4, etc., and transmitted via an Ethernet port to a gateway. For typical screen resolution video at 30 frames/second, this requires a bandwidth of approximately 2 to 4 Mbits/sec, assuming 100:1 compression. In another example, a reduced frame rate video (e.g., 10 frames/sec) may be highly compressed (e.g., 200:1) and transmitted via a CAN-FD link (e.g., at 250 kbits/sec) to the wireless connection module which may transmit the image data to the user device (e.g., via the cloud). Still pictures (i.e., single frames of image data) may be transferred in a universally accepted format such as JPEG, TIFF, PNG, etc. For example, a single frame may be transmitted at regular intervals (e.g., one every few seconds) and transmitted over CAN-FD to the wireless connection module. With a JPEG compression of 10:1, each still picture may be approximately 120 kbytes (i.e., 960 kbits or approximately 1000 kbits).

In the event the vehicle is parked in very dark surroundings (e.g., at night, in deep shade, in a parking garage, etc.), the 3D viewer module may transmit bus requests to one or more lighting modules to turn on headlights, taillights, reversing lights and/or sideward illumination lights (e.g., disposed at side mirrors of the vehicle) to help illuminate the surroundings. The 3D viewer module may select which lights to enable based on the requested view. For example, when the user requests video from a forward viewing camera, the 3D viewer module may instruct that the headlights illuminate the scene in front of the vehicle. As another example, when the user requests video from a rear viewing camera, the 3D viewer module may instruct rear facing lamps to illuminate the scene behind the vehicle. In the event an interior cabin view is required, cabin illumination may be enabled to illuminate the cabin of the vehicle. The system may disable the lights once image capture has stopped. The system may include one or more ambient light sensors or brightness sensors to determine whether the amount of ambient light at or around the vehicle is at or above a threshold level. When the ambient light is not above the threshold level, the system may determine additional illumination is needed (e.g., the headlights, etc.). In this situation, the system may automatically enable additional illumination. Optionally, the user may configure (e.g., via the application executing on the user device) whether the system enables additional illumination. For example, the application may include options allowing the user to enable various lighting systems of the vehicle in addition to selecting various camera views and composite images. The user may be able to monitor various other sensors in addition to or alternative to the cameras, such as microphones, temperature sensors, etc.

The system may automatically return to a low-power state once the user disconnects from the vehicle (e.g., closes the application). In the lower-power state, the system may refrain or limit from sending communications via the wireless communication channel and may reduce or stop capturing and/or processing sensor data (e.g., image data, audio data, etc.).

The communication system may utilize aspects of the systems described in U.S. Pat. Nos. 10,819,943; 9,555,736; 6,690,268; 6,693,517 and/or 7,580,795, and/or U.S. Publication Nos. US-2014-0375476; US-2014-0218529; US-2013-0222592; US-2012-0218412; US-2012-0062743; US-2015-0251599; US-2015-0158499; US-2015-0124096; US-2015-0352953; US-2016-0036917 and/or US-2016-0210853, which are hereby incorporated herein by reference in their entireties.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver’s awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640 × 480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least one million photosensor elements or pixels. The imaging array may capture color image data, such as via spectral filtering at the array, such as via an RGB (red, green and blue) filter or via a red / red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Pub. Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular vision system, the vehicular vision system comprising:
at least one camera disposed at a vehicle equipped with the vehicular vision system, the at least one camera capturing image data;
wherein the at least one camera comprises at least one million photosensing elements arranged in rows and columns;
wherein the vehicular vision system is operable to wirelessly communicate with a remote server;
an electronic control unit (ECU) comprising electronic circuitry and associated software;
wherein the electronic circuitry of the ECU comprises an image processor for processing image data captured by the camera;
wherein the vehicular vision system, responsive to receiving a remote viewing communication from a remote device exterior of and remote from the vehicle, (i) enables at least one light source of the vehicle to illuminate a region and (ii) captures one or more frames of image data representative of at least a portion of the illuminated region; and
wherein the vehicular vision system wirelessly transmits the one or more frames of image data to the remote device for display of images at the remote device that are representative of the illuminated region.

2. The vehicular vision system of claim 1, wherein the vehicular vision system communicates with the remote server via cellular communication, and wherein the remote server transmits the one or more frames of image data to the remote device via the Internet.

3. The vehicular vision system of claim 1, wherein the remote device comprises one selected from the group consisting of (i) a mobile phone of a user, (ii) a laptop of the user, and (iii) a desktop of the user.

4. The vehicular vision system of claim 1, wherein the remote viewing communication is generated in response to a user input received at an application executing on the remote device from a user of the remote device.

5. The vehicular vision system of claim 1, wherein the at least one camera comprises a plurality of cameras, and wherein the one or more frames of image data comprise frames of image data captured by each of the plurality of cameras, and wherein the frames of image data are transmitted to the remote device for display of a bird’s-eye view of the surroundings of the vehicle.

6. The vehicular vision system of claim 5, wherein the plurality of cameras includes (i) a rearward viewing camera disposed at a rear of the vehicle, (ii) a forward viewing camera disposed at a front of the vehicle, (iii) a left-side sideward and rearward viewing camera disposed at a left side of the vehicle and (iv) a right-side sideward and rearward viewing camera disposed at a right side of the vehicle.

7. The vehicular vision system of claim 6, wherein the displayed bird’s-eye view of the surroundings of the vehicle comprises a three dimensional (3D) surround view image.

8. The vehicular vision system of claim 6, wherein, responsive to another remote viewing command from the remote device, the frames of image data transmitted to the remote device are adjusted to provide a selected view to the remote device.

9. The vehicular vision system of claim 1, wherein the one or more frames of image data comprise video data.

10. The vehicular vision system of claim 1, wherein, prior to receiving the remote viewing communication, the vehicular vision system operates in a low-power state, and wherein, responsive to receiving the remote viewing communication, the vehicular vision system exits the low-power state.

11. The vehicular vision system of claim 1, wherein the vehicular vision system enables the at least one light source of the vehicle in response to determining that a level of ambient light at the vehicle is less than a threshold amount of ambient light.

12. The vehicular vision system of claim 1, wherein the at least one light source comprises at least one selected from the group consisting of (i) headlights of the vehicle, (ii) taillights of the vehicle and (iii) side mirror lights of the vehicle.

13. The vehicular vision system of claim 1, wherein the at least one camera comprises a plurality of cameras, each camera of the plurality of cameras viewing a different region interior or exterior the vehicle.

14. The vehicular vision system of claim 13, wherein the remote viewing communication selects a particular camera from the plurality of cameras, and wherein the one or more frames of image data are captured by the particular camera.

15. The vehicular vision system of claim 1, wherein the region is exterior of the vehicle, and wherein the at least one camera comprises an exterior viewing camera, and wherein the at least one light source comprises an exterior lighting light source of the vehicle.

16. The vehicular vision system of claim 1, wherein the region is within an interior cabin of the vehicle, and wherein the at least one camera comprises an interior camera viewing the interior cabin of the vehicle, and wherein the at least one light source comprises an interior cabin lighting light source of the vehicle.

17. A vehicular vision system, the vehicular vision system comprising:
at least one interior camera disposed within a vehicle equipped with the vehicular vision system and viewing interior of the vehicle, the at least one camera capturing image data;
wherein the at least one interior camera comprises at least one million photosensing elements arranged in rows and columns;
wherein the vehicular vision system is operable to wirelessly communicate with a remote server;
an electronic control unit (ECU) comprising electronic circuitry and associated software;
wherein the electronic circuitry of the ECU comprises an image processor for processing image data captured by the interior camera;
wherein the vehicular vision system, responsive to receiving a remote viewing communication from a remote device exterior of and remote from the vehicle, (i) enables at least one light source of the vehicle to illuminate a region within an interior cabin of the vehicle and (ii) captures one or more frames of image data representative of at least a portion of the illuminated region within the interior cabin of the vehicle; and
wherein the vehicular vision system wirelessly transmits the one or more frames of image data to the remote device via the Internet for display of images at the remote device that are representative of the illuminated region.

18. The vehicular vision system of claim 17, wherein the remote viewing communication is generated in response to a user input received at an application executing on the remote device from a user of the remote device.

19. The vehicular vision system of claim 17, wherein the vehicular vision system enables the at least one light source of the vehicle responsive to determination that a level of ambient light at the vehicle is less than a threshold amount of ambient light.

20. A vehicular vision system, the vehicular vision system comprising:
a plurality of cameras disposed at a vehicle equipped with the vehicular vision system, the plurality of cameras capturing image data;
wherein each camera of the plurality of cameras comprises at least one million photosensing elements arranged in rows and columns;
wherein the vehicular vision system is operable to wirelessly communicate with a remote server;
an electronic control unit (ECU) comprising electronic circuitry and associated software;
wherein the electronic circuitry of the ECU comprises an image processor for processing image data captured by each camera of the plurality of cameras;
wherein the vehicular vision system, responsive to receiving a remote viewing communication from a remote device exterior of and remote from the vehicle, (i) enables at least one light source of the vehicle to illuminate a region viewed by at least one camera of the plurality of cameras, (ii) captures a first one or more frames of image data by a first camera of the plurality of cameras and (iii) captures a second one or more frames of image data by a second camera of the plurality of cameras; and
wherein the vehicular vision system wirelessly transmits data to the remote device for display of images at the remote device that are representative of the first one or more frames of image data and the second one or more frames of image data.

21. The vehicular vision system of claim 20, wherein the plurality of cameras includes (i) a rearward viewing camera disposed at a rear of the vehicle, (ii) a forward viewing camera disposed at a front of the vehicle, (iii) a left-side sideward and rearward viewing camera disposed at a left side of the vehicle and (iv) a right-side sideward and rearward viewing camera disposed at a right side of the vehicle.

22. The vehicular vision system of claim 20, wherein the display of images at the remote device comprise a three dimensional (3D) surround view image.

23. The vehicular vision system of claim 20, wherein, responsive to another remote viewing command from the remote device, the first one or more frames of image data and the second one or more frames of image data transmitted to the remote device are adjusted to provide a selected view to the remote device.
